(19) United States
(12) Patent Application Publication
(10) Pub. No.: US 2023/0397623 A1
(43) Pub. Date: Dec. 14, 2023

(54) Method and Facility for the Treatment of Brine in Salt Baths for Salting Cheese

(71) Applicant: GEA TDS GmbH, Sarstedt (DE)

(72) Inventor: Bernd Feuerriegel, Berlin (DE)

(21) Appl. No.: 18/035,649

(22) PCT Filed: Oct. 15, 2021
(86) PCT No.: PCT/EP2021/000125

§ 371 Date: May 5, 2023

(30) Foreign Application Priority Data
Nov. 6, 2020 (DE) 10 2020 006 813.8

(51) Int. Cl. A23C 19/064; C02F 1/26; C02F 1/44; C02F 1/469; C02F 1/42

(52) U.S. Cl. CPC A23C 19/064; C02F 1/265; C02F 1/444; C02F 1/4693; C02F 1/42; C02F 2101/30

(57) ABSTRACT

A method and facility for the treatment of brine in salt baths for salting cheese are described. First fractions of dissolved salt are carried along in a cleaned brine permeate and second fractions of dissolved salt are carried along in a contaminated brine retentate. A first quantitative ratio between brine permeate and brine retentate is adjusted in such a manner that the quantity of brine retentate corresponds at least to the quantity of whey and constituents that pass into the brine in the salt bath during the dwell time. The cleaned brine permeate and the cleaned brine are merged in a controlled manner in a second quantitative ratio, by means of which the mixture of both components is concentrated to a salt concentration that corresponds at least to a required salt bath concentration.

### TECHNICAL FIELD

This disclosure relates to a method for the treatment of brine in salt baths for salting cheese. This disclosure also relates to a facility suitable for performing the method.

### BACKGROUND

In the applicable literature, the following cited information is quoted regarding salting out of cheese or, respectively, salting of cheese.

With regards to salting out of cheese, G. Roeder, Grundzüge der Milchwirtschaft und des Molkereiwesens (Introduction to Dairy Farming and the Dairy Industry), 1954, publisher Paul Parey, Hamburg and Berlin, states the following:
Properly salting the cheese is very important for the quality of the completed product. In addition to influencing the taste, it also serves to further extract whey and effects the formation of the rind or the surface of the cheese, the development of ripening bacteria, and the storage life of the cheese in a variety of ways. A differentiation is made between dry salting, treatment in a salt bath, direct salting.

With regards to salting of cheese, H. G. Kessler, Lebensmittel—und Bioverfahrenstechnik, Molkereitechnologie (Food and Bioprocess Engineering, Dairy Technology), 1996, publisher A. Kessler, Munich, states the following:
The salt bath with an NaCl concentration of 16 to 25% is used most frequently today. For hard cheese and semi-hard cheese, NaCl concentrations of 19 to 23% are used, and for soft cheese concentrations of 16 to 18% are used. The dwell time in the salt bath is on average 3 to 5 days for Emmental at 12 to 16° C. and up to 1 to 2 hours for Camembert at 16 to 20° C. While a higher temperature facilitates the diffusion speed of the salt in the cheese, it also leads to whey being released and thus to loss of mass. If the salt bath becomes too sour due to lactic acid passing into it, water with a corresponding NaCl content must be added, or it is blunted with lime (Ca(OH)₂). The pH should be approximately 5.2. The salt content in the bath must be monitored. It must be regularly supplemented. From time to time, the salt bath, into which protein, lactose, other residues and dust enter, should be replaced, at least filtered and boiled [for this, see FIG. 1a]. Infections with halophilic microorganisms can occur. A regenerated salt bath must be adjusted again to the required pH by adding lactic acid. The cheese reaches salt contents between 0.5 and 4% on average.

The technological information regarding salting cheese, which was kept very general in the above, will be handled in more detail below with regards to embodiments of the present invention. In large-scale industrial production of cheese today, salt is continuously added to the salt bath while the salt bath simultaneously overflows due to the additional whey and other constituents passing into the bath from the cheese. The overflow is used to wash out the contaminants in the salt bath, wherein the contaminated brine is discharged and possibly discarded. The contaminated brine becomes a disposal and processing problem due to a concentration of approx. 20% NaCl because of the associated high chloride load.

FIG. 1 shows a first facility known to the applicant, which cannot be verified by printed publications. In large-scale industrial production, the unsalted cheese is introduced, often continuously but also discontinuously and in batches, into a salt bath with a predetermined volume of brine with a starting salt content, and it leaves the bath with a salt content in the range given above. Regardless of the type of cheese and as indicated above, the brine in the salt bath contains, for example, 20% NaCl (corresponding to 0.2 kg/kg or 200 g/l). The cheese rind absorbs salt, whereby it swells and the cheese matrix of the cheese rind facilitates a material exchange. As the dwell time of the cheese in the salt bath progresses, whey passes into the brine through osmotic pressure, while salt diffuses out of the brine into the interior of the cheese, whereby the cheese absorbs a certain quantity of salt. This quantity of salt absorbed by the cheese is withdrawn from the brine of the salt bath. In addition, the escaping whey dilutes the salt concentration of the brine. As a result, salt must be continuously added to the brine to maintain the technologically required salt concentration.

The escaping whey contains additional dissolved and/or dispersed cheese components, also referred to as constituents in the following, such as inter alia proteins, minerals, microorganisms, and fats that pass into and contaminate the salt bath. The calcium originating from the cheesemaking milk and contained partially in the whey after cheese production passes into the salt bath with the whey as dissociated Ca²⁺ ions. As a result of this loss of calcium and the sodium absorption that this promotes, the cheese rind would swell too much and become soft as a result, which would negatively impact the storage stability of the cheese. Depending on the calcium concentration in the brine, the cheese releases more or fewer Ca²⁺ ions into the brine or absorbs some and, depending on the type of cheese, the fraction of Ca²⁺ ions in the brine is adjusted to stabilize the cheese rind. Therefore, in addition to the NaCl concentration, the calcium concentration in the salt bath is also held at a controlled high level to compensate as much as possible for the osmotic pressure of the Ca²⁺ ions from the cheese through additional dosing of CaCl₂ solution into the salt bath.

Additional dosing with NaCl— and CaCl₂ solution is required, as addressed already above, because the volume of the brine in the salt bath continuously increases as the whey quantity is received. Due to the limited receiving capacity of the salt bath, this additional volume is an overflow volume, which in large-scale industrial processing facilities is initially, for example, stacked in overflow tanks and then drained in what is known as “purging.”

During purging today, meaning the drainage of the excess brine from the salt bath system into the wastewater, the salt, and contaminants, including still-usable salt (NaCl and CaCl₂), are lost with the wastewater. Because the dissolved salts NaCl and CaCl₂ are present in a dissociated form and thus represent chloride suppliers, the CaCl₂ also therefore contributes to the chloride concentration (Cl⁻ ions) in the wastewater.

Accordingly, in purging today, particularly in the large-scale industrial production of cheese, the mentioned disposal problem and/or a problem of wastewater treatment arises, which can lead to considerable disposal and/or treatment costs. However, losses of significant salt loads also arise, which, if they are permanently lost for the salting process, represent in themselves another considerable cost factor. In the previously known procedure, as demonstrated by way of example in FIG. 1a, maintaining the hygiene of the salt bath requires additional equipment in the form of filters and heaters. While the filtering of the contaminated brine can be performed, for example, in the bypass to salting the cheese in a continuous salting process, boiling of the brine with the goal of killing harmful microorganisms can be performed only after the end of the salting process, i.e., by interrupting production, or during continuous production through additional equipment, for example, by branching off a part of the brine and stacking the same in a tank in connection with a separated heat treatment.

In, KAMMERLEHNER, J., Käsesalzungsverfahren—Minimierung der Natriumchloridverluste, Deutsche Milchwirtschaft (Cheese Salting Methods—Minimizing Sodium Chloride Losses, German Dairy Industry), Vol. 5, 1993, p. 326, 328, 330, 332-333, ISSN 0012-0480, a sodium chloride recycling method is disclosed in the context of salting cheese, which minimizes the common salt losses and lowers the environmental load when all of the liquid involved in salting is collected and reused and when the brine is completely regenerated by demineralization through electrodialysis and protein separation through ultrafiltration.

It is known to desalinate salt-containing solutions by means of an electrodialysis method and obtain primarily desalinated water, the diluate. In this case, the concentrate, which is enriched with salt and usually contaminated, is a waste product. DE Patent Publication No. 43 24 668 A1, for example, discloses a method for desalinating salt solutions by means of electrodialysis, with which desalinated water is obtained and the salt solution supplied to the electrodialyzer is concentrated.

DE Patent Publication No. 44 27 478 A1 also describes a method for treating common salt-containing fresh brine resulting from the pickling of vegetables, in particular sauerkraut. Initially, in a first separating apparatus, a fiber and suspended matter separating apparatus, course fibers are separated from the common salt-containing fresh brine in a container, which brine is largely separated from the pickled vegetables after the treatment of the pickled vegetables and discharged from the container. The brine is discharged as sludge with approximately 50% water content and discarded or otherwise used. From the remaining fresh brine discharged from the first separating apparatus, fine and super-fine material fractions can be discharged as retentate in the form of a suspension by means of a second separating apparatus designed as an ultrafiltration apparatus and discarded or otherwise used. Only the fresh brine preliminarily clarified in this way, the permeate, enters a third separating apparatus designed preferably as an electrodialysis apparatus. On the one hand, a diluate, which can be disposed of without issue due to the low common salt content and which contains the organic constituents, and, on the other hand, non-recyclable concentrate, are discharged from said apparatus. The remaining salt concentration accruing in the electrodialysis apparatus is recycled into the container in the common salt treatment of the pickled vegetables to be treated subsequently, wherein additional common salt quantities are introduced Oto increase the salt concentration to an approx. 25% common salt alkaline solution for salting the pickled vegetables.

It is an object of selected embodiments of the present invention to create a method and a facility for the treatment of brine in salt baths for salting cheese, with which the hygiene of the salt bath is improved, a significant recovery of the salt used is achieved, and the disposal costs for the excess brine to be discarded are considerably reduced.

### SUMMARY

A known, generic method for the treatment of brine in salt baths for salting cheese is characterized in that a cheese to be salted is introduced in batches or continuously into a predetermined volume of the brine in the salt bath, undergoes salting there for a specified dwell time, and leaves the salt bath, in batches or continuously accordingly, as salted cheese. During the dwell time, the brine is circulated and, as a result of the salting process, a certain quantity of whey and other constituents from the cheese passes into the predetermined volume of the brine in the salt bath. To keep the predetermined volume constant, an excess volume of a brine contaminated by the whey and the constituents is discharged from the salt bath and the concentration and quantity losses of salt and water in the brine in the salt bath are compensated for. The discharged contaminated brine is separated by a first membrane separation method into a brine permeate cleaned of the whey and the constituents and a brine retentate contaminated with the whey and the constituents. A desalination of the contaminated brine retentate by means of a second membrane separation method is also provided, which is configured so that at least a portion of dissolved salt is transferred into a flow of receiving water and dissolved therein, the water and the salt dissolved therein form a clean brine, and a correspondingly desalinated contaminated brine retentate is discarded as wastewater. Finally, the cleaned brine permeate and the cleaned brine are conducted into the brine in the salt bath.

Keeping the predetermined volume constant can be achieved in a simple manner in that the excess volume is realized in the form of an overflow volume.

A procedural solution approach that is known is to separate the discharged contaminated brine by means of a first membrane separation method into a brine permeate cleaned of the whey and the constituents and a brine retentate contaminated with the whey and the constituents. In this case, in accordance with embodiments of the present invention, first fractions of dissolved salt are carried along in the cleaned brine permeate and second fractions are carried along in the contaminated brine retentate. The cleaned brine permeate can thus be returned to the salt bath as a cleaned salt solution, whereas the contaminated brine permeate carries away all of the contaminants. In this separation process, salts can pass this membrane unhindered, whereas the contaminated constituents are retained in the retentate. Thus, the retentate and the permeate are estimated to contain the same concentrations of NaCl and CaCl₂). It is advantageous to place an apparatus for separating course constituents, for example, a sieve filter, upstream of the first membrane separation method, in the flow direction of the contaminated brine.

A second decisive solution approach is that a first quantitative ratio between the brine permeate and the brine retentate is adjusted in such a manner that the quantity of brine retentate corresponds at least to the quantity of whey and constituents that pass into the brine in the salt bath during the dwell time. This feature ensures that a balanced quantitative balance of the flows of matter involved in the entire treatment process is adhered to.

A solution approach that is known provides desalinating the contaminated brine retentate by means of a second membrane separation method, which is configured so that at least a portion of the second fractions of salt dissolved in the contaminated brine retentate is transferred into a flow of receiving water and dissolved therein. In this case, the water and the salt dissolved therein form a cleaned brine, and a correspondingly contaminated brine retentate is discarded as wastewater. Due to this measure of a substantial partial desalination, the salt load of the brine retentate can be largely recovered and returned to the salt bath as cleaned brine.

A third solution approach provides measuring a flow of the discharged contaminated brine in connection with the adjusted first quantitative ratio between the brine permeate and the brine retentate in such a manner that the chloride content in the desalinated contaminated brine retentate which is discarded as wastewater does not exceed a statutory limit for the introduction of this wastewater into surface water. On the one hand, it must be ensured that the excess volume is discharged from the system due to the quantitative ratio to be maintained, and on the other hand, this condition is necessary but not sufficient because the brine permeate and the brine retentate must be in the not freely selectable first quantitative ratio to each other (known as volume concentration factor VCF) due to the technological boundary conditions for the first membrane separation method. For this reason, the flow (feed) of the discharged contaminated brine fed to the first membrane separation method is also a variable to be freely dimensioned within limits in relation to the adjusted first quantitative ratio and according to a predetermined statutory limit to be maintained.

A fourth solution approach provides performing a controlled merging of the cleaned brine permeate and the cleaned brine in a second quantitative ratio, by means of which the mixture of both components is concentrated to a salt concentration that corresponds at least to a required salt bath concentration. This enables a balanced salt balance to be produced in a simple manner. The mixture ratio of the two components can be changed by a suitable control method, which also influences the feeding of the water to the second membrane separating apparatus, the flow of receiving water.

Due to the previously described first quantitative ratio, only a small fraction of the contaminated brine from the salt bath is treated with the second membrane separation method as contaminated brine retentate, while the majority is recirculated directly to the salt bath as cleaned brine permeate. That means that the ratio between sodium and calcium also remains substantially unchanged and is not shifted by the first membrane separation method.

The advantages of the method in accordance with the present invention in its entirety also include, in addition to the substantial recovery of the salt used and its return to the salt bath, of the chloride concentration in the wastewater being considerably lowered, and, in the most favorable case, below the permitted introduction limit for surface water. The salt recycling avoids considerable disposal costs and saves significant quantities of salt and thus corresponding production costs. The method in accordance with the present invention can be scaled with higher cheese throughput capacity so that production expansions that would otherwise not be possible due to the limitation in the wastewater disposal can be made.

By continuously filtering the salt bath, the hygiene of the salt bath increases in an advantageous manner, which positively affects the cheese quality. It positively promotes the material exchange process between the cheese and the brine when the brine is circulated.

The aforementioned requirements of the first membrane separation method are met in the most expedient way, as proposed, when the first membrane separation method is designed as an ultrafiltration membrane separation method, whereas the second membrane separation method is designed with regard to the aforementioned requirements as an electrodialysis method.

An optimal solution of the object underlying the present invention is achieved when the first membrane separation method is designed as an ultrafiltration method and at the same time the second membrane separation method is designed as an electrodialysis method.

The method in accordance with the present invention serves as a preferred manner to treat brine in which salt in the form of sodium chloride and/or calcium chloride is found or, respectively, are found in solution and in which the constituents contaminating the brine occur in the form of protein, lactose, lactic acid, other residues, and dust.

A facility for the treatment of brine in salt baths for salting cheese that is suitable for performing the method in accordance with the present invention has the following features:
a salt bath unit that receives the brine in the salt bath;
a cheese provision unit, from which a cheese to be salted is fed to the specific volume of brine in the salt bath in batches or continuously;
a salt provision unit, from which the salt is fed to the brine in the salt bath;
a water provision unit that provides water for the brine in the salt bath; and
a cheese receiving unit that receives a cheese salted in the brine in the salt bath during a dwell time, in batches or continuously accordingly.

In contrast to the generic prior art, the facility according to the present invention is characterized in that:
a first brine separating unit is connected to the salt bath in a fluid-conducting manner via a brine discharge line and the first brine separating unit is configured to separate a brine discharged from the salt bath and contaminated by whey and other constituents from the cheese into a brine permeate cleaned of the whey and the constituents and a brine retentate contaminated with the whey and the constituents, wherein first fractions of dissolved salt are carried along in the cleaned brine permeate and second fractions of dissolved salt are carried along in the contaminated brine retentate;
a control apparatus is provided that is in controlling connection with a status information of the salt bath via a first control connection and with the first brine separating unit via a second control connection and is configured to dimension a flow of the discharged contaminated brine and to adjust a first quantitative ratio between the brine permeate and the brine retentate in such a manner that the quantity of brine retentate corresponds at least to the quantity of whey and constituents that passes into the brine in the salt bath during the dwell time;
a second brine separating unit is provided and configured to transfer, by means of a second membrane separation method, the contaminated brine retentate into a wastewater through desalination, wherein the chloride content of the wastewater does not exceed a statutory limit for the introduction into surface water, wherein the second fractions of salt dissolved in the contaminated brine retentate are transferred into a flow of water and are dissolved therein, and the water and the salt dissolved therein form a cleaned brine;
the second brine separating unit is connected, in each case in a fluid-conducting manner, on the one hand, to a concentrate drain line for the contaminated brine retentate, which leads to the first brine separating unit, and to a first brine feed line for the cleaned brine and, on the other hand, to a wastewater line for the wastewater with a wastewater receiving apparatus and to the water provision unit via a water feed line for the water; and
a permeate drain line for the cleaned brine permeate and the brine feed line are each connected in a fluid-conducting manner to the salt bath.

The combination of a first brine separating unit upstream of the second brine separating unit, wherein both have different separating tasks, is an advantageous feature that allows the contaminated brine to be separated into a contaminated brine retentate to be treated further and a cleaned brine permeate to be fed without treatment. In addition, the combination enables a control apparatus to dimension a flow of the discharged contaminated brine and adjust a first quantitative ratio between the brine permeate and the brine retentate in such a manner that the quantity of brine retentate corresponds at least to the quantity of whey and constituents that pass into the brine in the salt bath during the dwell time.

The additional advantages and special features compared to a facility of the generic type according to the prior art are evident analogously from the previously described method in accordance with the present invention, which can be performed with the facility in accordance with the present invention.

The first brine separating unit is at best expediently designed as an ultrafiltration unit and, independently of this design, the second brine separating unit is at best expediently designed as an electrodialysis unit. An optimal solution of the object underlying the invention is achieved when the first brine separating unit is designed as an ultrafiltration unit and at the same time the second brine separating unit is designed as an electrodialysis unit.

To achieve a sufficient quantitative separation capacity, the electrodialysis unit typically includes multiple ion exchange membrane stacks, at least, however, of one stack.

An advantageous embodiment of the facility also provides that the permeate drain line and the first brine feed line are merged in a brine concentration unit and are connected from there in a fluid-conducting manner to the salt bath via a second brine feed line. As a result, on the one hand, simple piping is created and, on the other hand, with the concentration unit an adjustment apparatus is created with which the control according to the invention of the salt concentration is performed in the second brine feed line leading to the salt bath.

The necessary increase of the salt bath concentration to a required value is very simple when the control apparatus is in controlling connection with the brine concentrating unit via a third control connection and is configured to achieve a controlled merging of the cleaned brine permeate and the cleaned brine in a second quantitative ratio, by means of which the mixture of both components is concentrated to a salt concentration that corresponds at least to the required salt bath concentration.

### BRIEF DESCRIPTION OF THE DRAWINGS

FIG. 1 shows a flow chart of a known method and at the same time, in a schematic representation, the arrangement of a known first facility according to the prior art, from which the present invention substantially originates.

FIG. 1a also shows a flow chart of another known method and at the same time, in a schematic representation, starting from the known first facility, the arrangement of a known second facility which shows a section from the first facility according to FIG. 1, wherein the contaminated brine can be filtered and heated (boiled) as needed.

The invention is represented in more detail by the following description, the appended figures, and the claims. While the invention is realized in a wide variety of embodiments of a preferred method in accordance with the present invention and a facility in accordance with the present invention for the performance thereof, the drawings show a preferred facility in accordance with the present invention with which a preferred embodiment of the method is performed. The facility is described below according to structure and function, and the method is described below in conjunction with the facility.

FIG. 2 shows a flow chart of a method in accordance with the present invention and at the same time, in a schematic representation, the arrangement of a facility in accordance with the present invention with a first brine separating unit designed as an ultrafiltration unit and a second brine separating unit designed as an electrodialysis unit.

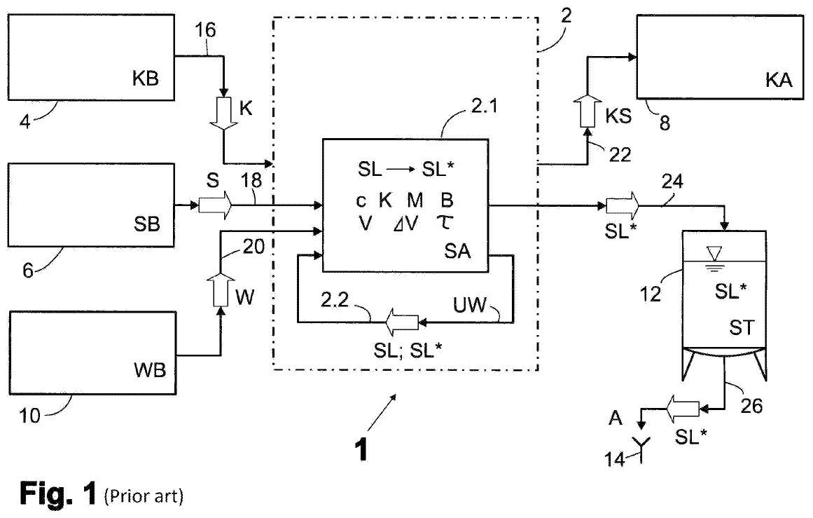

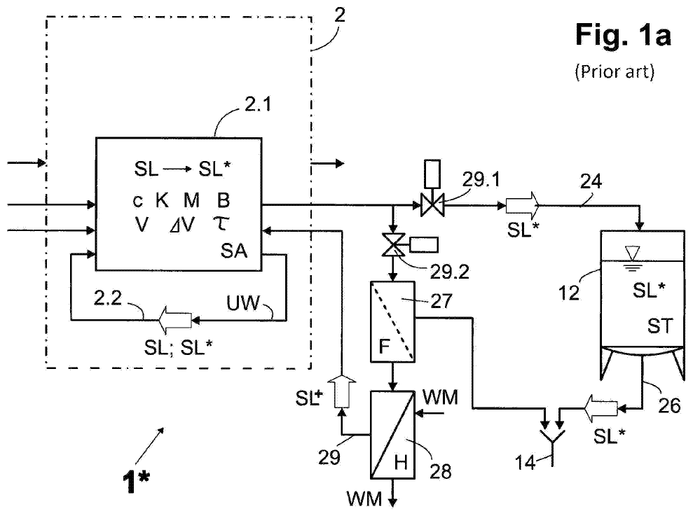

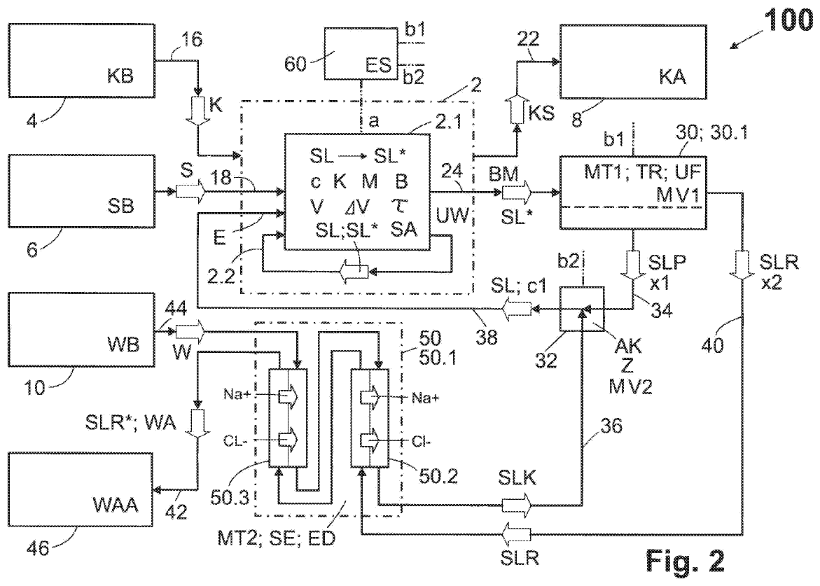

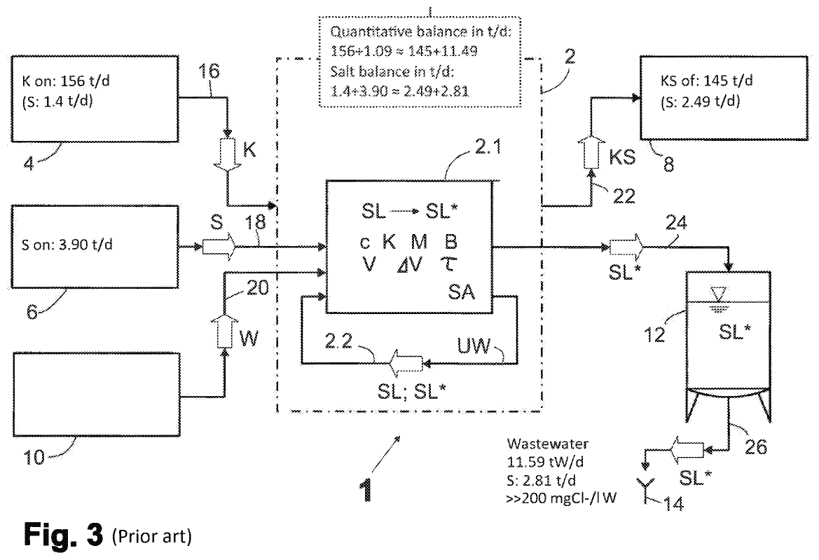

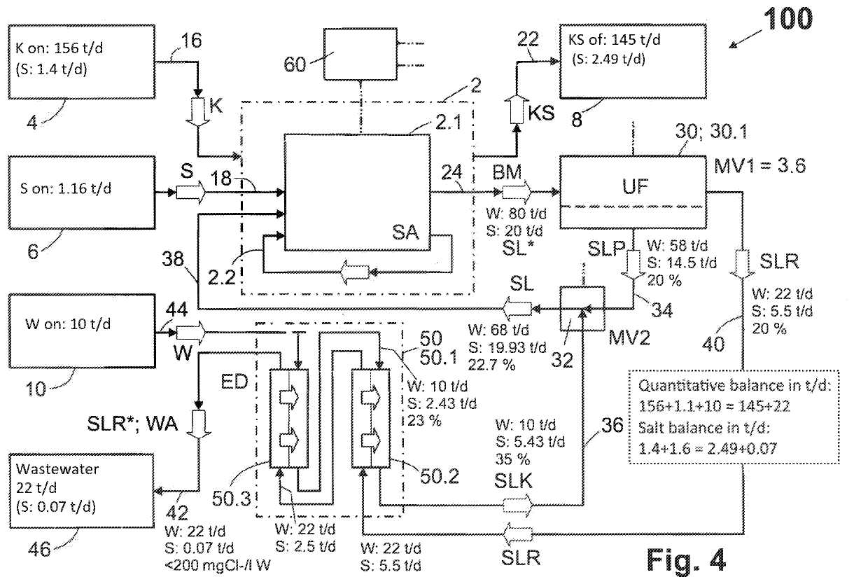

FIG. 3 shows a schematic representation of the arrangement of the known facility according to FIG. 1, supplemented with quantity and salt flows.

FIG. 4 shows a schematic representation of the arrangement of the facility in accordance with the present invention according to FIG. 2, supplemented with quantity and salt flows.

### DETAILED DESCRIPTION

Referring to FIG. 1, a known first facility 1 for the treatment of brine SL in salt baths 2.1 for salting SA (unsalted) cheese K includes a salt bath unit 2, which receives a predetermined volume V of the brine SL in the salt bath 2.1. The unsalted cheese K is fed from a cheese provision unit 4 (providing cheese KB) to the salt bath 2.1 via a cheese feed apparatus 16 in batches or continuously. Salt S is introduced into the salt bath 2.1 from a salt provision unit 6 (providing salt SB) via a salt feed apparatus 18 for the purpose of increasing a required salt bath concentration c in the salt bath 2.1 and water W is fed to the salt bath 2.1 from a water provision unit 10 (providing water WB) via a water feed line 20 for the purpose of a possibly necessary compensation of a quantity loss. A cheese receiving unit 8 (receiving cheese KA) is also provided, which receives a cheese KS salted in the salt bath 2.1 by the salting SA, in batches or continuously accordingly, on the path through a cheese discharge apparatus 22.

The salt bath 2.1 has a required salt bath concentration c that is adapted to the respective unsalted cheese K to be salted during a dwell time T. The brine SL is circulated, for example, via a circulation line 2.2 (circulating UW) designed as a bypass to the salt bath 2.1. Other circulating apparatuses that have a circulating effect (e.g., pump) within the salt bath 2.1 are also implemented. Whey M and other constituents B escaping from the unsalted or, respectively, salted cheese K, KS during salting SA enter the brine SL, as a result of which it becomes a contaminated brine SL* over the course of the dwell time T.

Over the course of the dwell time τ, the contaminated brine SL* exceeds a predetermined capacity of the salt bath 2.1, the predetermined volume V, due to the whey M and the other constituents B passing into it, and a resulting excess volume ΔV, an overflow volume, is forced into an overflow tank 12, for example, via a brine discharge line 24, stacked there (stacking ST), and from there discarded (purging A) if necessary into a drain 14 via a brine drain line 26.

Referring to FIG. 1a, a known second facility 1* for the treatment of brine SL in salt baths 2.1 for salting SA (unsalted) cheese K is built basically identically to the previously described known first facility 1. A difference is that contaminated brine SL* is branched off from the brine discharge line 24 if necessary by corresponding switching of a first shutoff valve 29.1 arranged in the brine discharge line 24 and a second shutoff valve 29.2, which is arranged in a branching line 29 branching off from the brine discharge line 24, is freed from contaminants and harmful microorganisms by a filter 27 (filtering F) arranged in the branching line 29 and an adjoining heater 28 (heating or, respectively, boiling H), and is fed to the salt bath 2.1 as a filtered and boiled brine SL+. The heater 28 is preferably a recuperator to which a heat transfer medium WM is applied on the secondary side. The contaminants to be discharged from the filter 27 are conducted out into the drain 14.

Referring to FIG. 2, a facility 100 in accordance with the present invention for the treatment of brine SL in salt baths 2.1 for salting SA (unsalted) cheese K can, as in the exemplary embodiment, be built identically or nearly identically with regard to the components, features, and associated functions mentioned for the known first facility 1 according to FIG. 1. This includes all of the reference signs listed in the reference sign list under FIGS. 1 and 3 with the exception of the overflow tank 12, drain 14, water feed line 20, brine drain line 26, purging A, and stacking ST. In order to avoid repetitions, the description for FIG. 1 is referenced.

Compared to the known first facility 1, the facility 100 in accordance with the present invention is built as follows. A first brine separating unit 30 (separating TR) is connected to the salt bath 2.1 in a fluid-conducting manner via the brine discharge line 24. The first brine separating unit 30 is configured to separate the contaminated brine SL* discharged from the salt bath 2.1 into a cleaned brine permeate SLP and a contaminated brine retentate SLR by means of a first membrane separation method MT1, wherein first fractions x1 of dissolved salt S are carried along in the cleaned brine permeate SLP and whey M and other constituents B that contaminate the contaminated brine SL* are retained in the contaminated brine retentate SLR. The cleaned brine permeate SLP is discharged via a permeate drain line 34 and the contaminated brine retentate SLR is discharged via a retentate drain line 40.

A control apparatus 60 is provided, which is connected in a controlling manner to a status information of the salt bath 2.1 via a first control connection a and to the first brine separating unit 30 via a second control connection b1. The control apparatus 60 is configured to dimension a flow of the discharged contaminated brine SL* or, respectively, to adjust it to a necessary volume flow (dimensioning BM) and adjust (adjusting ES) a first quantitative ratio MV1 between the brine permeate SLP and the brine retentate SLR in such a manner that the quantity of brine retentate SLR corresponds at least to the quantity of whey M and constituents B that pass into the brine in the salt bath 2.1 during the dwell time τ;

A second brine separating unit 50 is provided and configured to transfer the contaminated brine retentate SLR into wastewater WA through desalination by means of a second membrane separation method MT2. In doing so, at least a portion of second fractions x2 of salt S dissolved in the contaminated brine retentate SLR is transferred into a flow of water W, which is fed (providing water WB) out of the water provision unit 10 via a water feed line 44, and the water W and the salt S dissolved therein form a cleaned brine SLK.

On the one hand, the second brine separating unit 50 is connected to the retentate drain line 40 for the contaminated brine retentate SLR, which leads to the first brine separating unit 30, and to a first brine feed line 36 for the cleaned brine SLK, in each case in a fluid-conducting manner. On the other hand, the brine separating unit 50 is connected to a wastewater drain line 42 for the wastewater WA or, respectively, for a desalinated contaminated brine retentate SLR* to a wastewater receiving apparatus 46 (receiving wastewater WAA) and to the water provision unit 10 via the water feed line 44 for the water W, in each case in a fluid-conducting manner.

In a first embodiment, the permeate drain line 34 for the cleaned brine permeate SLP and the brine feed line 36 are each connected to the salt bath 2.1 in a fluid-conducting manner.

According to a second embodiment, the permeate drain line 34 and the first brine feed line 36 are merged (controlled merging Z; concentrating AK) in a fluid-conducting manner in a brine concentrating unit 32 and are connected in a fluid-conducting manner from there to the salt bath 2.1 via a second brine feed line 38 (introducing E). The controlled merging Z takes place with a second quantitative ratio MV2 between the cleaned brine permeate SLP and the cleaned brine SLK. For this purpose, the control apparatus 60 is in controlling connection with the brine concentrating unit 32 via a third control connection b2. In the latter, the two mixture components are dimensioned so that in the mixture a salt concentration c1 sets in that corresponds at least to the required salt bath concentration c.

According to an advantageous and particularly expedient embodiment, the first brine separating unit 30 is designed as an ultrafiltration unit 30.1 (ultrafiltration method UF), which has, for example, the first quantitative ratio MV1=3.6 (known as a volume concentration factor VCF). The consequences from this parameter are shown in the example given further below (quantitative balances).

According to another advantageous and particularly expedient embodiment, the second brine separating unit 50 is designed as an electrodialysis unit 50.1 (electrodialysis method ED). The electrodialysis unit 50.1 has at least one first ion exchange membrane stack 50.2; 50.3; . . . .

Due to the action mechanism of the electrodialysis method ED, sodium ions Na⁺ to a high degree and calcium ions Ca²⁺ (not shown) to a very small degree escape from the contaminated brine retentate SLR and, to a correspondingly high or, respectively, very low degree, chlorine ions Cl— (chloride) enter into the flow of water W fed to the electrodialysis unit 50.1 via the water feed line 44 and form the cleaned brine SLK in the first brine feed line 36 opening out from the electrodialysis unit 50.1.

Optimal separation results are achieved, as is also provided, when the first brine separating unit 30 is designed as an ultrafiltration unit 30.1 and is operated in connection with the second brine separating unit 50 designed as an electrodialysis unit 50.1.

The method that can be performed with the previously described facility 100 in accordance with the present invention has the following generic features, which are known per se, shown in FIG. 2. The unsalted cheese K is introduced in batches or continuously into the predetermined volume V of the brine SL of the salt bath 2.1, undergoes salting SA there during the specified dwell time τ, and then leaves the salt bath 2.1, in batches or continuously accordingly, as salted cheese KS. During salting SA, whey M and other constituents B pass from the cheese K, KS into the predetermined volume V. To keep the predetermined volume V constant, the excess volume ΔV of the brine SL* contaminated by the whey M and the other constituents B is discharged from the salt bath 2.1. Concentration and quantity losses of the brine SL are compensated for in the salt bath 2.1 by adding salt S and water W.

Method steps (i) to (iv) according to the invention are the following:
(i) First fractions x1 of dissolved salt S are carried along in the cleaned brine permeate SLP and second fractions x2 of dissolved salt S are carried along in the contaminated brine retentate SLR. The first membrane separation method MT1 is configured to carry along first fractions x1 of dissolved salt S in the brine permeate SLP and to retain constituents B, which contaminate the contaminated brine SL*, in the contaminated brine retentate SLR.
(ii) Adjusting ES the first quantitative ratio MV1 between the brine permeate SLP and the brine retentate SLR in such a manner that the quantity of brine retentate SLR corresponds at least to the quantity of whey M and constituents B that pass into the brine SL in the salt bath 2.1 during the dwell time T.
(iii) Dimensioning BM a flow of the discharged contaminated brine SL* in connection with the adjusted first quantitative ratio MV1 in such a manner that a chloride content Cl— in the desalinated contaminated brine retentate SLR* does not exceed a statutory limit for the introduction of the desalinated contaminated brine retentate SLR* into surface water.
(iv) Merging Z, in a controlled manner, the cleaned brine permeate SLP and the cleaned brine SLK in a second quantitative ratio, by means of which the mixture of both components is concentrated AK to a salt concentration c1 that corresponds at least to a required salt bath concentration c.

The first membrane separation method MT1 is preferably designed as an ultrafiltration method UF and the second membrane separation method MT2 is preferably designed as an electrodialysis method ED, wherein optimal separation results are achieved when the first membrane separation method MT1 is designed as an ultrafiltration method UF and is operated in connection with the second membrane separation method MT2 designed as an electrodialysis method ED.

The method is particularly suitable for recycling salt S in contaminated brine SL* from the process of salting SA cheese in the form of sodium chloride (NaCl) and/or calcium chloride (CaCl₂) and for separating the other constituents B from the contaminated brine SL* such as protein, lactose, lactic acid, other residues, and dust.

The following calculation estimates show a quantitative and salt balance for the method in accordance with the present invention that is performed with the facility 100 in accordance with the present invention described above and the associated estimated salt and cost savings.

### EXAMPLES

Starting Situation in Many Cheese Factories:
Adding cheese K in batches or continuously at X kgK/h and a starting salt content xs in kgS/kgK to a salt bath 2.1 with predetermined volume V of brine SL and correspondingly discharging from the salt bath 2.1 in batches or continuously at Y KgK/h and a salt content of ys in kgS/kgK. Typically, the following applies: X>Y and xs<ys.
The brine SL in the salt bath contains, depending on the type of cheese, approx. 20% NaCl (0.2 kgS/kgSL or 200 gS/1 SL-1: liter).
The cheese rind absorbs brine SL, whereby it swells and the cheese matrix of the cheese rind becomes permeable.
As the dwell time z of the cheese K in the salt bath 2.1 progresses, water (whey M) passes into the brine SL through osmotic pressure, while salt S diffuses out of the brine SL into the interior of the cheese, whereby the cheese K absorbs a quantity of salt according to equation (1)

ΔS=Y ys−X xs (1).
This quantity of salt ΔS absorbed by the cheese K is withdrawn from the brine SL of the salt bath 2.1. In addition, the escaping whey M dilutes the brine SL, as a result of which salt S must be continuously added to the brine SL to maintain the required salt bath concentration c.
The escaping whey M contains additional dissolved/dispersed cheese components (including proteins, minerals, microorganisms, fats) that pass into the brine SL in the salt bath 2.1, referred to above as constituents B, and continuously pollute it (contaminated brine SL*).
The calcium originating from the cheesemaking milk and contained partially in the whey M after cheese production passes into the salt bath with the whey as dissociated Ca²⁺ ions. As a result of this loss of calcium and the sodium absorption, the cheese rind would swell too much and become soft as a result, which would be disadvantageous for the stability of the cheese K. Therefore, in addition to the NaCl concentration, the CaCl₂) concentration in the salt bath 2.1 is also held at a controlled high level in order to compensate as much as possible for the osmotic pressure of the Ca²⁺ ions from the cheese K through additional dosing of CaCl₂) solution into the salt bath. Additional dosing is required because the brine SL in the salt bath 2.1 continuously increases in volume as the whey quantity is absorbed and the reservoir of the salt bath 2.1 would effectively overflow. In the industrial salting process, this “overflow,” an overflow volume or excess volume ΔV, is initially caught in overflow tanks and then drained in a targeted manner during the process known as “purging.” During purging A today, meaning the drainage of the excess brine from the salt bath system into the wastewater, the salt and contaminants contained therein, including NaCl and CaCl₂), are lost with the wastewater. Since the dissolved salts NaCl and CaCl₂) are present in a dissociated form, the CaCl₂) also thus contributes to the chloride concentration (Cl⁻ ions) in the wastewater.

### Example 1

### Prior Art—Operating Values Achieved

Quantitative and salt balance in the example of a large-scale industrial cheese-salting process, in which the cheese K to be salted is introduced in batches or continuously into a predetermined volume V of the brine SL in the salt bath 2.1 and leaves the salt bath 2.1, in batches or continuously accordingly, as salted cheese KS.
X=92,000 kgK/d of cheese K go into the salt bath 2.1 with a natural salt content of xs=salt S (xs=0.009 kgS/kgK) and thus carry X xs=828 kgS/d with them (d: day).
25,000 kg of salt S are introduced into the salt bath 2.1 for the purpose of salting over a time period of approx. 11 days, meaning approx. 2,300 kgS/d, corresponding to approx. 830 tS/a (at approx. 350 d/a), and thus at approx. 70 €/tS results in salting costs of approx. 56,000 €/a (t: ton, a: year).
4,950 lSL/d of brine purging+2,700 lSL/d of salt bath filter emptying result in 7,650 lSL/d of brine loss (lSL/d=liter SL/d).
Wastewater/loss at 19.5% salt concentration (0.195 kgS/kgSL) at a density of 1.11 kgSL/lSL result in approx. 8,490 kgSL/d of brine SL, which are divided into approx. 0.195×8,490=1,680 kgS/d of salt S and 6,830 kgW/d of (water+constituents).
   [symbol] Yearly salt losses in the wastewater at around 580 tS/a at 70 €/tS result in purging costs of more than 40,000 €/a.
   [symbol] From the emission of 580 tS/a, a chloride emission of approx. 351 tCl-/a and a sodium emission of approx. 230 tNa+/a result via the molar masses of sodium (22.99) and chlorine (35.45).
The cheese K absorbs (2,300−1,600)=640 kgS/d of salt S and emits 6,830 kgW/d (W here stands for: water+constituents).
   [symbol] Usable salt absorption approx. 640 kgS/d of salt S and at 350 d/a correspondingly 224 tS/a of salt S.
   [symbol] (92,000−6,830+640)=85,810 kgK/d of salted cheese KS leaves the salt bath 2.1.
   [symbol] After the salt bath 2.1, 85,810 kgK/d of salted cheese KS contain in total (828+640)=1,468 kgS/d of salt S, which corresponds to a salt content ys=1,468 kgS/d/(85,810 kgK/d)=0.017 kgS/kgK (1.7%).
Approximately 1,000 l/a of 22% CaCl₂ solution with a density p=1.198 kg/l (http://www.periodensystem-online.de) result in 264 kg of CaCl₂/a (corresponding to kg of CaCl₂/d at 350 d/a). They are continuously additionally dosed to maintain CaCl₂ (0.004 kgCaCl₂/kgW; W=water+constituents) in the salt bath 2.1 (analysis value for Ca²⁺=0.0015 kgCa²⁺/kgSL, with the molar ratio of 40 (Ca)/11,098 (CaCl₂) corresponds to a concentration of 0.4% CaCl₂ in water+constituents).
   [symbol] With 6,830 kgW/d, 6,830×0.004=27 kg/d CaCl₂ (=10 kgCa²⁺/d+17 kgCL-/d) go into the wastewater, at 350 d/a correspondingly 6 tCl-/a.
Added wastewater costs due to chloride content Cl—>200 mg/l(water+constituents) (>kgCl-/kg(water+constituents) at 0.13 €/kgCl— amount to
   [symbol] (351+6) tCl-/a×130 €/tCl-=approx. 46,000 €/a.
   [symbol] The chloride ions Cl— in the wastewater from CaCl₂ play only a subordinate role compared to the chloride ions Cl— in the wastewater from NaCl.
The total costs due to salt loss+added wastewater costs alone at approx. 40,000+46,000 amount to more than=86,000 €/a.

### Example 2

Expansion of the facility according to example 1 from 92,000 kg/d=92 t/d of unsalted cheese K by a factor of 1.7 to 156 t/d of unsalted cheese K (scaling of the values from example 1 with a scaling factor of 1.7).
156 tK/d of cheese K with xs=0.009 kgS/kgK go into the salt bath 2.1 (1,400 kgS/d).
3,900 kgS/d=1,360 tS/a at 70 €/tS result in salting costs of approx. 95,000 €/a.
13,000 lSL/d of brine loss SL at 19.5% salt concentration at a density of 1.11 kgSL/lSL result in approx. 14,400 kgSL/d of brine SL, which are divided into approx. 2,810 kgS/d of salt S and approx. 11,590 kgW/d of (water+constituents).
   [symbol] Yearly salt loss in the wastewater at around 990 tS/a at 70 €/tS result in purging costs of approx. 70,000 €/a.
   [symbol] From the emission of 990 tS/a, a chloride emission of approx. 600 tCl-/a and a sodium emission of approx. 390 tNa+/a result via the molar masses of sodium (22.99) and chlorine (35.45).
The cheese K absorbs (3,900−2,810)=1,090 kgS/d of salt S and emits 11,590 kgW/d of (water+constituents).
   [symbol] Usable salt absorption approx. 1,090 kS/d of salt S and at 350 d/a correspondingly 382 tS/salt S.
   [symbol] (156−11.59+1.09)=145 tK/d of salted cheese KS leaves the salt bath 2.1.
   [symbol] Additional CaCl₂ dosing delivers 10 tCl-/a into the wastewater.
Added wastewater costs due to chloride content Cl—>200 mg/l(water+constituents) (>kgCl-/kg(water+constituents) at 0.13 €/kgCl—
   [symbol] (600+10) tCl-/a×130 €/tCl->79,000 €/a.
The total costs due to salt loss+added wastewater costs alone at approx. 70,000+79,000 amount to more than=149,000 €/a.

### Example 3

Example 3 starts from the salting process shown and estimated in example 2 (scaling factor of 1.7 compared to the salting process according to example 1) and with the objective of
hygienic cleaning of the salt bath 2.1
efficient salt recycling
maintaining max. 200 mgCl-/l(water+constituents) corresponding to 0.0002 kgCl-/kg(water+constituents) corresponding to 320 mgNaCl/kg(water+constituents) corresponding to 0.00032 kgNaCl/kg(water+constituents) into surface water shows the results which can be achieved, and which are shown in FIG. 4 with the method in accordance with the present invention and the facility for the performance thereof according to FIG. 2 compared to the known method according to example 2, shown in FIGS. 1 and 3. A detailed calculation estimate is omitted. The relevant results of examples 2 and 3 are shown as a comparison in the following table:

| Item | | Example 2 | Example 3 |
|---|---|---|---|
| Unsalted cheese K | tK/d | 156 | 156 |
| Salted cheese KS | tK/d | 145 | 145 |
| Salting - salt S | tS/d | 3.90 | 1.16 |
| Salt loss NaCl (in wastewater) | tNaCl/d | 2.81 | 0.07 |
| Chloride Cl— (in wastewater) | tCl—/d | 1.70 | 0.04 |
| Chloride Cl— limit | mg/l W | >>200 | <200 |

The following is a list of reference signs used in this specification and in the drawings.

### FIGS. 1 and 3 (Prior Art)

1 Known first facility
2 Salt bath unit
2.1 Salt bath
2.2 Circulation line
4 Cheese provision unit
6 Salt provision unit
8 Cheese receiving unit
10 Water provision unit
12 Overflow tank
14 Drain
16 Cheese feed apparatus
18 Salt feed apparatus
20 Water feed line
22 Cheese discharge apparatus
24 Brine discharge line
26 Brine drain line
A Purging
B Constituents
K Unsalted cheese
KA Receiving cheese
KB Providing cheese
KS Salted cheese
M Whey
S Salt
SA Salting
SB Providing salt
SL Brine (originally prepared or cleaned)
SL* Contaminated brine
ST Stacking
UW Circulating
V Predetermined volume
ΔV Excess volume
W Water
WB Providing water
c Required salt bath concentration
τ Dwell time

### FIG. 1a (Prior Art)

1* Known second facility
27 Filter
28 Heater
29 Branching line
29.1 First shutoff valve
29.2 Second shutoff valve
F Filtering
H Heating (boiling)
SL+Filtered and boiled brine
WM Heat transfer medium
FIGS. 2 and 4
100 Facility
30 First brine separating unit
30.1 Ultrafiltration unit
32 Brine concentrating unit
34 Permeate drain line
36 First brine feed line
38 Second brine feed line
40 Retentate drain line
42 Wastewater drain line
44 Water feed line
46 Wastewater receiving apparatus
50 Second brine separating unit
50.1 Electrodialysis unit
50.2 First ion exchange membrane stack
50.3 Second ion exchange membrane stack
60 Control apparatus
AK Concentrating
BM Dimensioning
Ca²⁺ Calcium ions
CaCl₂ Calcium chloride
CL- Chlorine ions (chloride)
E Introducing
ED Electrodialysis method
ES Adjusting
MT1 First membrane separation method
MT2 Second membrane separation method
MV1 First quantitative ratio
MV2 Second quantitative ratio
Na+Sodium ions
NaCl Sodium chloride
SE Desalinating
SLK Cleaned brine
SLP Cleaned brine permeate
SLR Contaminated brine retentate
SLR* Desalinated contaminated brine retentate
TR Separating
UF Ultrafiltration method
WAA Receiving wastewater
WA Wastewater (e.g., diluate)
Z Merging (controlled)
a First control connection
b1 Second control connection
b2 Third control connection
c1 Salt concentration (mixture of SLP+SLK)×
z1 First fractions
x2 Second fractions

1. A method for treatment of brine in a salt bath for salting cheese, comprising:
introducing a cheese to be salted in batches or continuously into a predetermined volume of the brine in the salt bath, wherein the cheese undergoes salting there during a specified dwell time, and leaves the salt bath, in batches or continuously accordingly, as salted cheese;
circulating the brine during the specified time;
passing, during the salting, whey and other constituents from the cheese into the predetermined volume;
discharging, to keep the predetermined volume at a constant volume, an excess volume of a contaminated brine that is contaminated by the whey and the other constituents from the salt bath;
compensating for concentration and quantity losses of salt and water in the brine in the salt bath;
separating, by means of a first membrane separation method, the contaminated brine that is discharged into a cleaned brine permeate that is cleaned of the whey and the other constituents and a contaminated brine retentate that is contaminated with the whey and the other constituents;
desalinating the contaminated brine retentate by means of a second membrane separation method, which is configured so that at least a portion of the salt is transferred into a flow of receiving water and dissolved therein, wherein the receiving water and the salt dissolved therein form a cleaned brine, and a desalinated contaminated brine retentate is discarded as wastewater;
introducing the cleaned brine permeate and the cleaned brine into the brine in the salt bath;
carrying first fractions of dissolved salt in the cleaned brine permeate and second fractions of dissolved salt in the contaminated brine retentate;
adjusting a first quantitative ratio between the cleaned brine permeate and the contaminated brine retentate in such a manner that the quantity of the contaminated brine retentate corresponds at least to the quantity of the whey and the other constituents that pass into the brine in the salt bath during the specified dwell time;
dimensioning a flow of the contaminated brine that is discharged in connection with the adjusted first quantitative ratio in such a manner that a chloride content in the desalinated contaminated brine retentate does not exceed a statutory limit for introduction of the desalinated contaminated brine retentate into surface water; and
merging, in a controlled manner, the cleaned brine permeate and the cleaned brine in a second quantitative ratio, by means of which a mixture of both components is concentrated to a salt concentration that corresponds at least to a required salt bath concentration.

2. The method according to claim 1, wherein the first membrane separation method is designed as an ultrafiltration method.

3. The method according to claim 1, wherein the second membrane separation method is designed as an electrodialysis method.

4. The method according to claim 2, wherein the second membrane separation method is designed as an electrodialysis method.

5. The method according to claim 1, wherein the salt is at least one or sodium chloride or calcium chloride.

6. The method according to claim 1, wherein the other constituents comprise at least one of protein, lactose, lactic acid.

7. A facility for treatment of brine in salt baths for salting cheese, comprising:
a salt bath unit that receives the brine in the salt bath;
a cheese provision unit, from which a cheese to be salted is fed to a specific volume of the brine in the salt bath in batches or continuously;
a salt provision unit, from which salt is fed to the brine in the salt bath;
a water provision unit that provides water for the brine in the salt bath;
a cheese receiving unit that receives a cheese salted in the brine in the salt bath during a dwell time, accordingly in batches or continuously;
a first brine separating unit is connected to the salt bath in a fluid-conducting manner via a brine discharge line, wherein the first brine separating unit is configured to separate, using a first membrane separation method, a brine discharged from the salt bath and contaminated by whey and other constituents from the cheese into a brine permeate that is cleaned of the whey and the other constituents and a brine retentate that is contaminated with the whey and the other constituents, and wherein first fractions of dissolved salt are carried along in the brine permeate and second fractions of dissolved salt are carried along in the brine retentate;
a control apparatus in controlling connection with a status information of the salt bath via a first control connection and with the first brine separating unit via a second control connection, wherein the control apparatus is configured to dimension a flow of the brine discharged from the salt bath and to adjust a first quantitative ratio between the brine permeate and the brine retentate in such a manner that the quantity of brine retentate corresponds at least to the quantity of the whey and the other constituents that passes into the brine in the salt bath in during the dwell time;
a second brine separating unit configured to transfer, using a second membrane separation method, the brine retentate into a wastewater through desalination, wherein:
a chloride content of the wastewater does not exceed a statutory limit for introduction into surface water;
the second fractions of dissolved salt in the brine retentate are transferred into a flow of water and are dissolved therein, and the water and the salt dissolved therein form a cleaned brine; and
the second brine separating unit is connected, in a fluid-conducting manner, to a concentrate drain line for the contaminated brine retentate, which leads to the first brine separating unit, and to a first brine feed line for the cleaned brine and connected, in a fluid-conducting manner, to a wastewater line for the wastewater with a wastewater receiving apparatus and to the water provision unit via a water feed line for the water; and
a permeate drain line for the brine permeate, wherein the permeate drain line and the brine feed line are each connected in a fluid-conducting manner to the salt bath.

8. The facility according to claim 7, wherein the first brine separating unit is designed as an ultrafiltration unit.

9. The facility according to claim 7, wherein the second brine separating unit is designed as an electrodialysis unit.

10. The facility according to claim 8, wherein the second brine separating unit is designed as an electrodialysis unit.

11. The facility according to claim 9, wherein the electrodialysis unit has at least one first ion exchange membrane stack.

12. The facility according to claim 7, wherein the permeate drain line and the first brine feed line are merged in a fluid-conducting manner in a brine concentrating unit, and are connected in a fluid-conducting manner from there to the salt bath via a second brine feed line.

13. The facility according to claim 12, wherein the control apparatus is in controlling connection with the brine concentrating unit via a third control connection and is configured to achieve a controlled merging of the brine permeate and the cleaned brine in a second quantitative ratio, by means of which a mixture of both components is concentrated to a salt concentration that corresponds at least to a required salt bath concentration.

14. The method according to claim 1, wherein the salt is sodium chloride.

15. The method according to claim 1, wherein the salt is calcium chloride.

16. The method according to claim 2, wherein the other constituents comprise at least one of protein, lactose, lactic acid, or dust.

17. The method according to claim 3, wherein the other constituents comprise at least one of protein, lactose, lactic acid, or dust.

18. The facility according to claim 10, wherein the electrodialysis unit has at least one first ion exchange membrane stack.

19. The facility according to claim 8, wherein the permeate drain line and the first brine feed line are merged in a fluid-conducting manner in a brine concentrating unit, and the permeate drain line and the first brine feed line are connected in a fluid-conducting manner from there to the salt bath via a second brine feed line.

20. The facility according to claim 9, wherein the permeate drain line and the first brine feed line are merged in a fluid-conducting manner in a brine concentrating unit, and the permeate drain line and the first brine feed line are connected in a fluid-conducting manner from there to the salt bath via a second brine feed line.
